(19) United States
(12) Patent Application Publication
(10) Pub. No.: US 2012/0079409 A1
(43) Pub. Date: Mar. 29, 2012

(54) WORKFLOW MANAGEMENT AT A DOCUMENT PROCESSING DEVICE

(76) Inventors: Guiluan Luo, Dublin, CA (US); Jiang Hong, San Jose, CA (US); Zhenyu Lu, Sunnyvale, CA (US); Kaoru Watanabe, Sunnyvale, CA (US); Jayasimha Nuggehalli, Cuperino, CA (US)

(21) Appl. No.: 12/892,155

(22) Filed: Sep. 28, 2010

(51) Int. Cl. G06F 3/048

(52) U.S. Cl. 715/772

(57) ABSTRACT

Approaches are provided for workflow creation and management at a scanning device. In one approach, a user initiates a plurality of operations to be performed on, or relative to, scanned document data. A workflow that represents the sequence of operations is created. The workflow may be created with or without user input. The workflow is later provided as an option to a user. Upon selection of the option, the sequence of operations is performed without requiring the user to select each operation separately. In a related approach, a user is also allowed to create a workflow by selecting graphical representations of operations and causing the graphical representations to be arranged in a particular order to create a workflow that may be later selected.

### RELATED CASES

This application is related to:

U.S. patent application Ser. No. 12/873,116, filed Aug. 31, 2010, entitled “Sending Scanned Document Data Through A Network To A Mobile Device”;

U.S. patent application Ser. No. 12/871,528, filed Aug. 30, 2010, entitled “Approach For Processing Scanned Document Data”;

U.S. patent application Ser. No. 12/872,829, filed Aug. 31, 2010, entitled “Push Scan To An Existing Document”; and

U.S. Patent Application Serial No. 12/873,034, filed August 31, 2010, entitled “Tracking The Processing Of Electronic Document Data By Network Services Using Trace”; each of which is incorporated by reference as if fully set forth herein.

### FIELD OF THE INVENTION

This invention relates generally to workflow management, and more specifically, to an approach for managing workflow at a multi-functional peripheral.

### BACKGROUND

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

Many individuals and business organizations are scanning an increased number of printed documents. Maintaining documents in electronic form requires less space and allows documents to be accessed by multiple users, without having to make additional printed copies. One of the issues with scanning documents is the difficulty of distributing the scanned document data to intended recipients. Distribution of scanned document data may be performed at a scanning device where the printed document is first scanned. Some scanning devices allow a user to specify a destination for the scanned document data, for example by selecting a location or recipient from an address book or contact list. The scanning device then transmits the scanned document data to the selected location or recipient.

Distribution of scanned document data may also be performed from another location. For example, a user may scan a printed document and select their name as the recipient. The scanning device transmits the scanned document data to the user, for example, by sending the scanned document data as an email attachment to the user's personal computer. The user then uses their email client to forward the scanned document data to one or more other recipients. Both of these approaches require multiple steps and can be cumbersome when contact information for the intended recipient is not already stored in either the scanning device or the user's email client, because the user has to manually enter the recipient's contact information, for example by typing an email address of the recipient.

This problem is addressed by U.S. patent application Ser. Nos. 12/873,116, 12/871,528, 12/872,829, 12/873,034, referenced above.

The increased sophistication of scanning devices (and, optionally, the network services that support them) allows users to select a number of different operations to perform. A further issue that may arise in the context of scanning printed documents is that a user (or multiple users) may initiate the performance of the same sequence of operations for many different scan jobs. For example, a user inserts 10 sheets of printed documents into an input tray for scanning. The user then (1) selects a scan button on the scanning device, (2) instruct the scanning device to store the scanned document data on the scanning device and/or via a network storage service, (3) instruct an OCR operation to be performed on the scanned document data to generate text data, and (4) instruct the text data to be sent to the user's mobile device. In a subsequent session, if the user requires the same operations to be performed with respect to a different set of printed documents, then user is required to select the same series of buttons, whether graphical on a display or physical on the scanning device. This selection of the same operations is repetitive, error prone, and can be time consuming, resulting in a negative user experience.

### SUMMARY

An approach is provided for generating a workflow. A first user initiates the performance of each operation of a plurality of operations, which are performed in association with scanned document data generated by a scanning device. In response, workflow data that indicates each of said plurality of operations is generated and stored. After the workflow data is stored and in response to a second user interacting with the scanning device, a graphical element, based on the workflow data, is displayed on a graphical user interface (GUI) of the scanning device. In response to selection of the graphical element, the performance of each of said plurality of operations is initiated.

In a related approach, a plurality of graphical elements are displayed on a graphical user interface (GUI) of a scanning device. The plurality of graphical elements allow a user to create a workflow. A workflow represents a plurality of operations that, upon user selection of the workflow, are executed without requiring user input to initiate performance of each of the plurality of operations. In response to creation of the workflow, the workflow is stored for later retrieval. After the workflow is stored, a particular graphical element is displayed on the GUI of the scanning device. The particular graphical element represents the workflow. In response to user selection of the particular graphical element, the plurality of operations, associated with the workflow, are performed without user input being required to initiate performance of each of the plurality of operations.

### BRIEF DESCRIPTION OF THE DRAWINGS

In the figures of the accompanying drawings like reference numerals refer to similar elements.

FIG. 1 is a block diagram that depicts an example architecture for processing scanned document data.

FIG. 2 depicts an example operation panel of a scanning device.

FIG. 3 is a flow diagram 300 that depicts an approach for generating a workflow.

FIG. 4 is a message ladder diagram 400 that depicts an example message exchange between a user and elements of FIG. 1 during the creation of a workflow.

FIG. 5 is a diagram that depicts an example set of GUI controls that allow a user to create a workflow.

FIGS. 6A-B are block diagrams that depict GUI controls that allow a user to build a workflow.

FIG. 7 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention. Various aspects of the invention are described hereinafter in the following sections:

### I. OVERVIEW

### II. SCANNED DOCUMENT DATA PROCESSING ARCHITECTURE

A. SCANNING DEVICE

B. CLOUD

C. CLIENTS

D. OPERATION PANEL
1. WORKFLOW OPTIONS

### III. WORKFLOW GENERATION

A. AUTOMATIC WORKFLOW GENERATION
1. OPERATION SELECTION HISTORY
2. EXAMPLE OPERATIONS
3. TRACKING OPERATION SELECTION HISTORY
4. ESTABLISHING A WORKFLOW
5. PROVIDING WORKFLOW OPTIONS

B. WORKFLOW BUILDER
1. SIMPLE WORKFLOW
2. COMPLEX WORKFLOW
3. BUILDING A WORKFLOW EXAMPLE
4. STORING A WORKFLOW

C. MODIFYING A WORKFLOW

### IV. IMPLEMENTATION MECHANISMS

### I. Overview

Approaches are provided for creating a workflow. In one approach, a user's (or multiple users') operation selection history at a scanning device is tracked in order to automatically create a workflow that represents previously-selected operations. The workflow is provided to a user who can select the workflow instead of having to select each operation represented by the workflow. Thus, selection of a workflow causes the operations represented by the workflow to be performed without further user input that selects each of those operations.

In a related approach, one or more GUI controls are provided that allow a user to graphically create a workflow, which can later be selected by the user. In a related approach, one or more GUI controls are provided that allow a user to select and modify an existing workflow.

### II. Scanned Document Data Processing Architecture

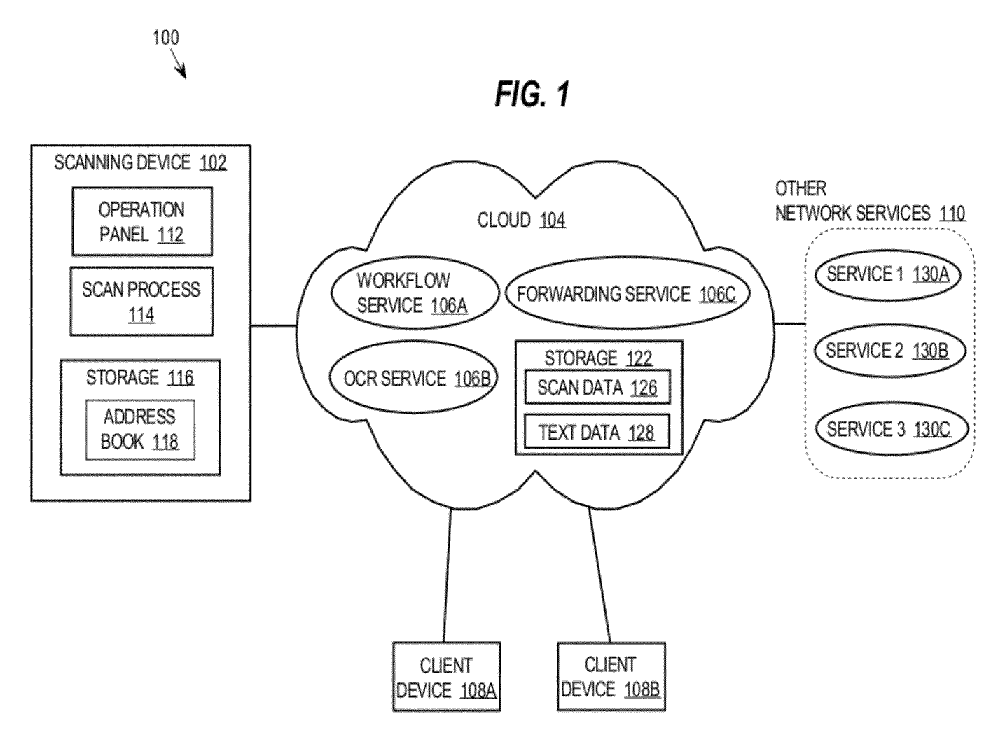

FIG. 1 is a block diagram that depicts an example architecture for processing scanned document data. Architecture 100 includes a scanning device 102, a cloud 104, client devices 108A, 108B, and other network services 110 that are each communicatively coupled to cloud 104. For illustration purposes only, other network services 110 includes services 130A-C. However, embodiments of the invention are not limited to these three network services. There may be any number (including zero) of other network services 110 that are communicatively coupled to cloud 104.

The links between cloud 104 and each of scanning device 102, client devices 108A, 108B, and other network services 110 may be implemented by any medium or mechanism that provides for the exchange of data between the elements of FIG. 1. Examples of such links include, without limitation, a network such as a Local Area Network (LAN), Wide Area Network (WAN), Ethernet or the Internet, or one or more terrestrial, satellite or wireless links.

### A. Scanning Device

Scanning device 102 is a device that includes the capability to scan one or more printed documents and generate scanned document data that represents the one or more printed documents. The scanned document data may be in a variety of formats, depending upon a particular implementation. One example format is the portable document format (PDF) by Adobe Systems, Inc. Scanning device 102 may also include a capability to convert scanned document data from a non-text format, such as PDF, to a text-based format, using for example, optical character recognition (OCR). Scanning device 102 may also include the capability to transmit the scanned document data to another location or device, for example, to a computer connected to the scanning device 102 or over a network to a network device. Examples of scanning device 102 include, without limitation, a scanner and a multi-function peripheral (MFP) that includes one or more functions in addition to scanning, such as printing, copying, faxing, etc.

Scanning device 102 includes an operation panel 112, a scan process 114, and storage 116. If scanning device 102 is a MFP, then scanning device might include, e.g., a print process and a fax process (not shown).

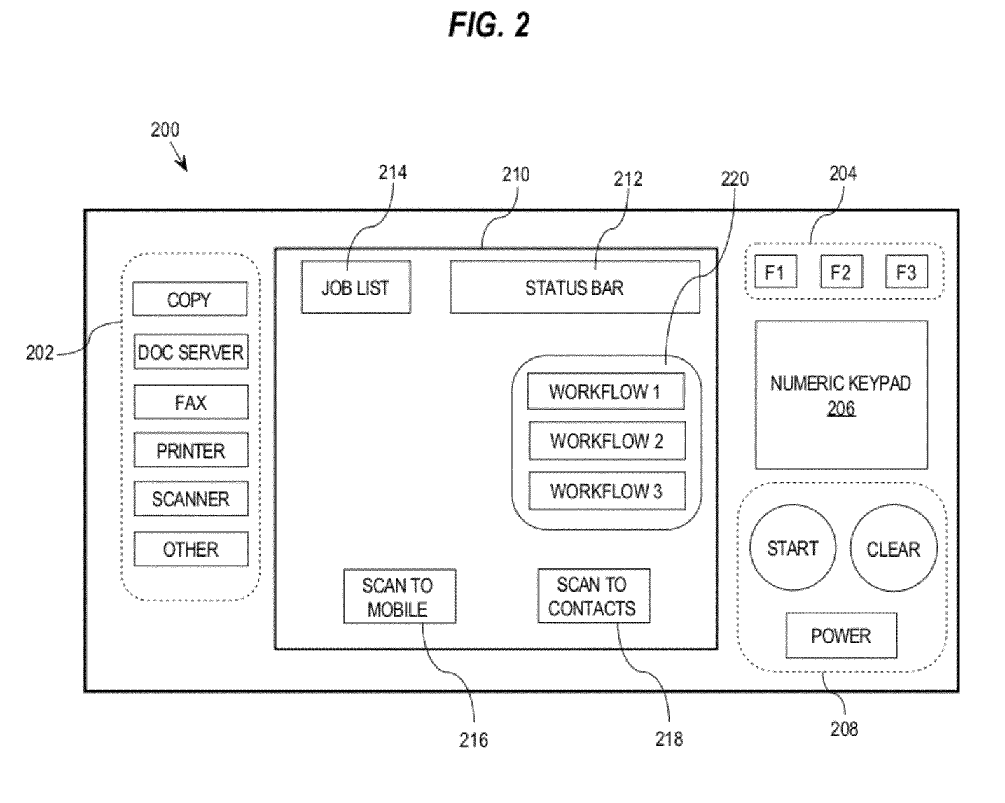

The operation panel 112 is configured to display information to a user and to accept user input. The particular implementation of the operation panel 112 may vary depending upon a particular implementation. For example, the operation panel 112 may include a screen on which a graphical user interface (GUI) is displayed. In addition, the screen may be a touch screen that allows a user to select icons and GUI objects on the GUI. The GUI may be updated to reflect changes in the functionality offered by the scanning device 102. The operation panel 112 may also include control buttons and a numeric keypad for receiving user input. Operation panel 112 is described in more detail below with reference to FIG. 2.

Scan process 114 is configured to cause one or more printed documents to be scanned by scanning device 102 and generate scanned document data that represents the one or more printed documents. Scan process 114 may be initiated, for example, in response to a user selection of the start user control 208 (depicted in FIG. 2) or user selection of a GUI object included in GUI 210 (depicted in FIG. 2).

Storage 116 may be any combination of volatile or non-volatile storage for storing data used by scanning device 102. For example, the storage 116 may be random access memory (RAM), one or more disks, or any combination of RAM and one or more disks for storing scanned document data and/or electronic data based on scanned document data. As depicted in FIG. 1, storage 116 may store an address book 118 or contact data that is used by scanning device 102, for example, to obtain destination addresses for transmitting scanned document data. Scanning device 102 may include other modules and processes that are not depicted in FIG. 1 for purposes of brevity.

### B. Cloud

A “cloud” is a computing system providing access via the Internet to processing power, storage, software or other computing services, often via a web browser. Thus, cloud 104 is viewed as a collection of services from the perspective of scanning device 102 and client devices 108A and 108B. At the hardware level (although transparent to scanning device 102 and client devices 108A and 108B), cloud 104 comprises one or more network devices that host the plurality of services.

Each of the services in a cloud is accessible via the Internet using an IP protocol. Thus, each service in (or hosted by) a cloud may be associated with a different IP address and/or port number.

A cloud may be maintained by a single individual or organization (e.g., company). However, multiple organizations may share responsibility in maintaining a particular cloud. A network service “outside” of a particular cloud (e.g., one of other network services 110) is provided by one or more individuals or organizations that are different than any individual or organization that maintains the particular cloud. One or more of the services in a cloud may rely on such services that are outside of the cloud.

In FIG. 1, cloud 104 includes a workflow network service (or simply “workflow service”) 106A. Workflow service 106A processes and manages workflow-related data as described in more detail hereinafter.

Cloud 104 may also include an OCR service 106B for converting scanned document data in non-text format, for example PDF, into text-based format. Cloud 104 may also include a forwarding service 106C for transmitting scanned document data in text format to one or more recipients. OCR service 106B and forwarding service 106C are depicted in FIG. 1 as being separate from workflow service 106A for purposes of explanation, but OCR service 106B and forwarding service 106C may be implemented as being part of workflow service 106A.

Storage 122 may be implemented as any type of volatile or non-volatile storage for storing data used by workflow service 106A. For example, storage 122 may be random access memory (RAM), one or more disks, or any combination of RAM and one or more disks for storing scanned document data. Storage 122 may store scanned document data 126 received by and/or processed by workflow service 106A, text data 128 generated by OCR service 106B, and/or contact data (not shown) extracted by workflow service 106A from the text data generated by OCR service 106B.

### C. Clients

Client devices 108A, 108B receive scanned document data and/or text data from workflow service 106A, as described in more detail hereinafter. Client devices 108A, 108B may be implemented as any type of client device. Examples of client devices 108A, 108B include, without limitation, personal or laptop computers, workstations, cellular telephony devices such as cell phones, personal digital assistants (PDAs), etc.

### D. Operation Panel

FIG. 2 depicts an example operation panel 200 of the scanning device 102. Operation panel 200 includes a set of user interface controls 202 for activating functions of the scanning device 102. The functions depicted in FIG. 2 includes copy, connect to a document server, fax, print, copy, and other functions. These functions are provided as examples of typical functions that may be implemented on a scanning device that is an MFP, but the functions implemented on any particular scanning device may vary depending upon the implementation.

Operation panel 200 also includes a set of function buttons 204 that may be assigned to various functions provided on scanning device 102. Operation panel 200 also includes a numeric keypad 206 and a set of user controls 208 for toggling the power, starting a function and clearing the current function. These are examples of the user controls that are typically included on a scanning device. More or fewer user controls may be provided, depending upon a particular implementation.

Operation panel 200 also includes a GUI 210 for displaying information and receiving user input. GUI 210 may be displayed via a touch screen that is capable of detecting user selection of icons and GUI objects displayed on GUI 210. GUI 210 may be stored on scanning device 102 and loaded directly from local storage of scanning device 102 (e.g., storage 116).

Alternatively, GUI 210 is provided by workflow service 106A or another service in cloud 104. A browser (not shown) executing on scanning device 102 may request GUI 210 from a service in cloud 104. The browser may send a HTTP request in response to, for example, user selection of the scanning function on the set of UI controls 202 or startup of scanning device 102. In this way, GUI 210 may be updated remotely at any time before GUI 210 is loaded onto scanning device 102. Also, by relying on a service of cloud 104 for GUI 210, scanning device 102 is removed from the responsibility for persistently storing, updating, or otherwise maintaining GUI 210.

In the present example, GUI 210 includes a status bar GUI object 212 that displays status information, such as the status of the scanning device 102 or the status of one or more scan jobs. GUI 210 also includes a job list GUI object 214 which, when selected, displays a list of jobs associated with the scanning device 102. The list may be of scan jobs that have been processed and/or scan jobs that are currently being processed. A scan job may be associated with a distinct set of scanned document data that is generated in response to the initiation of a single scan operation. Thus, one scan job may be of 5 printed documents while another scan job may be of 500 printed documents.

GUI 210 may include any number of other GUI objects depending upon a particular implementation, and the GUI objects depicted in FIG. 2 are provided as non-limiting examples.

In an embodiment, GUI 210 includes a scan-to-mobile GUI object 216. User selection of scan-to-mobile GUI object 216 causes scanning device 102 to send the scanned document data (or, e.g., text data generated from the scanned document data) to one or more mobile devices (e.g., client devices 108A, 108B) via cloud 104. User selection of scan-to-mobile GUI object 216 may initiate the scanning of one or more printed documents to generate scanned document data. Alternatively, one or more printed documents may be scanned prior to user selection of GUI object 216. Thus, in this scenario, user selection of GUI object 216 does not initiate the scanning of the one or more printed documents. Instead, user selection of GUI object 216 causes the already-scanned document data to be sent to one or more mobile devices via cloud 104.

GUI 210 may include one or more GUI objects (not shown) and/or other user controls (not shown) that allow a user to identify one or more phone numbers. As part of the scan-to-mobile operation, scanning device 102 sends the one or more phone numbers to cloud 104 along with scanned document data in order for one or more services in cloud 104 to send the scanned document data (or other data generated therefrom) to mobile device(s) identified by the phone number(s).

A user may identify the one or more phone numbers in at least two ways. For example, the user may enter the one or more phone numbers into GUI 210 using numeric keypad 206. The phone number(s) may be stored locally or remotely for later retrieval and display by scanning device 102 so that the user is not required to enter in the phone number(s) again.

Additionally or alternatively, the one or more GUI objects that allow a user to identify one or more phone numbers may allow a user to select the one or more phone numbers from a list, i.e., without requiring the user to physically enter the phone numbers into scanning device 102. The list of phone numbers may be stored locally (i.e., on scanning device 102) or remotely by a service in cloud 104. One or more of the phone numbers in the list may have been submitted by a client device (e.g., client device 108A or 108B) to a contact service (or workflow service 106A) in cloud 104. The list of phone numbers may be loaded from cloud 104 onto scanning device 102 when GUI 210 is requested from cloud 104 or when scan-to-mobile GUI object 216 is selected.

Whether persistently stored locally or remotely, the list of phone numbers may be stored in association with the user. For example, a user may be associated with a unique identifier. In response to the user logging into scanning device 102 and selecting scan-to-mobile GUI object 216, scanning device 102 uses the user's unique identifier to identify the list of phone numbers associated with the unique identifier. Alternatively, workflow service 106A (or another service in cloud 104) uses the user's unique identifier (received from scanning device 102) to identify the list of phone numbers associated with the unique identifier.

Additionally or alternatively to GUI 210 including one or more GUI objects that allow a user of scanning device 102 to identify one or more phone numbers, workflow service 106A (or another service in cloud 104), identifies one or more phone numbers in the scanned document data (or, e.g., in text data 128). Thus, for example, a user may include a business card (or another document with a phone number) along with the one or more printed documents in the scan process. In this way, a user is not required to identify any of the phone numbers.

In an embodiment, GUI 210 includes a scan-to-contacts GUI object 218. User selection of scan-to-contacts GUI object 218 causes scanning device 102 to send the scanned contact data to one or more mobile devices (e.g., client devices 108A, 108B) via cloud 104 or to a contact service in cloud 104, as described in more detail hereinafter. User selection of scan-to-contacts GUI object 218 may initiate the scanning of one or more printed documents (such as business cards) to generate scanned contact data. Alternatively, one or more printed documents may be scanned prior to user selection of GUI object 218. Thus, in this scenario, user selection of GUI object 218 does not initiate the scanning of the printed document(s). Instead, user selection of GUI object 218 causes the already-scanned document data to be sent to cloud 104.

User selection of scan-to-contacts GUI object 218 may cause a list of one or more user accounts to be displayed on GUI 210. Each user account may be associated with a username and password (or other authorization data, such as a unique token) to authorize the addition of the contact information to the user account. The list of one or more user accounts may be user accounts only of the user that selected the scan-to-contacts GUI object 218. Alternatively, the list of one or more user accounts may include a user account of a user other than the user that selected the scan-to-contacts GUI object 218.

The list of user accounts may be accounts previously registered by a user using one or more GUI objects (not shown) on GUI 210 and/or using user controls (not shown)of scanning device 102. Additionally or alternatively, the list of user accounts may be submitted by a client device (e.g., client device 108A or 108B) to a contact manager service (or workflow service 106A) in cloud 104. The list of user accounts may be loaded from cloud 104 onto scanning device 102 when GUI 210 is requested from cloud 104 or when scan-to-contacts GUI object 218 is selected. A user may select, in the list, one or more of the user accounts to which the scanned contact data (or data generated therefrom) will be sent.

1. Workflow Options

In an embodiment, GUI 210 includes a list of workflow options 220. In this example, the list of workflow options 220 includes three workflow options that may be selected: Workflow 1, Workflow 2, and Workflow 3, each indicating a different workflow. Although only three workflows are indicated in workflow options 220, there may be more or less workflows. If there are no workflows, then workflow options 220 does not include any workflow options or is not included in GUI 210.

User selection of a workflow option in workflow options 220 causes the set of operations of the corresponding workflow to be performed. The set of operations are performed without the user having to select each operation in the set. In an embodiment, once a workflow option is selected, no further user input is required in order for all the operations in the set to be performed.

Each workflow indicated in workflow options 220 may correspond to the same set or different set of operations. If two or more workflows indicate the same set of operations, then the order in which the operations are performed may be different.

Each workflow indicated workflow options 220 may be a default workflow, an automatically-generated workflow, or a user-created workflow, each of which are described in more detail below. A workflow indicated in workflow options 220 may be a “private” workflow (which is viewable and/or selectable only by the user that is logged into scanning device 102) or may be “public” in that the workflow may be viewable and selectable by any user that uses scanning device 102.

### III. Workflow Generation

### A. Automatic Workflow Generation

According to an embodiment of the invention, a workflow is automatically generated based on previously-selected operations with respect to scanned document data or data generated based on the scanned document data. The previously-selected operations may be performed by scanning device 102, workflow service 106A, and/or another service in cloud 104 or outside cloud 104. Other than an indication of which operations were selected by a user, a workflow may be generated with no (or very little) user input. The workflow may be generated by scanning device 102 or a service in cloud 104, such as workflow service 106A. The primary input used to automatically generate a workflow is “operation selection history.”

1. Operation Selection History

“Operation selection history” is data that indicates the operations that were selected by a user during, as part of, or after, one or more scan jobs. Each user that initiates a series of operations may be associated with his/her own operation selection history. Thus, each user may be associated with a unique identifier that is also associated with the operation selection history of that user. The operation selection history of a user may be identified (e.g., by scanning device 102 or workflow service 106A) when the user logs into the scanning device. Logging into a scanning device might require the user to enter data that authenticates the user. This data may be used to retrieve the user's operation selection history. Additionally or alternatively, operation selection history may include operation selection history of multiple users but that are not stored as being associated with any particular user.

2. Example Operations

Non-limiting examples of operations that users can select and that may be indicated in operation selection history include (1) a scan operation to generate scanned document data, (2) a security operation to encrypt the scanned document data and/or lock the scanned document so that only users with a certain password have access to the content of the scanned document data, (3) a region detection operation to detect certain regions, of one or more printed documents reflected in the scanned document data, that satisfy certain criteria, (4) an OCR operation to generate text data from the scanned document data, (5) a text-to-speech operation to convert text data to audio data, (6) a message operation to send of a message (e.g., a multimedia message service (MMS) message) containing scanned document data (or data generated therefrom) to one or more mobile devices, (7) an email operation to send an email to one or more recipients, and (8) a store operation to store the scanned document data in persistent storage (whether on scanning device 102, in cloud 104, or other network service 110).

3. Tracking Operation Selection History

Scanning device 102, workflow service 106A, or both entities may be configured to track the selection of these (and other) user-initiated operations. In an embodiment, an identification of each selected operation is sent to workflow service 106A even though each selected operation is initiated at scanning device 102. Thus, workflow service 106A may track the operation selection history for each user that operates scanning device 102 and determine when to generate a workflow. Although the following description describes workflow service 106A performing various steps to track and maintain operation selection history and provide workflow data to scanning device 102, such steps may additionally or alternatively be performed by scanning device 102.

For example, a user selects the scan user interface control 202 to generate scanned document data based on one or more printed documents. The user then selects one or more user interface controls to convert the scanned document data to text data (e.g., in a Word format) and then to store the text data in network service 1 130A. The user then selects scan-to-mobile GUI object 216 to cause the scanned document data to be sent to one or more mobile devices. Finally, the user selects scan-to-contacts GUI object 218 to send contact data that is identified in the scanned document data (or in the text data) to a contact service in cloud 104.

Workflow service 106A receives an identification of each operation selected by the user. Workflow service 106A determines when the user is done selecting any operations with respect to the scan job. This determination may be made by determining (a) when the user is logged off of scanning device 102, (b) when the user initiates another scan process (e.g., by selecting the scan user interface control 202), or (c) how much time has elapsed since the last operation was initiated at scanning device 102. In response to determining that the user is finished selecting operations, workflow service 106A stores the identification of the selected operations as a (at least possible) workflow in operation selection history, e.g., maintained for the user. A workflow is an identification of a set of operations that were selected by a user with respect to a specific scan job, which corresponds to a specific set of scanned document data.

4. Establishing a Workflow

In an embodiment, after a user initiates a set of operations, workflow service 106A prompts the user if the user would like to store the current set of operations as a workflow, which can be later presented to and selected by the user. An example prompt may be a message sent by workflow service 106A to scanning device 102, where the message is displayed on GUI 210 and indicates that the current set of operations selected by the user as a workflow. The message indicates each operation visually (e.g., with an icon) and/or with a text description.

If the user indicates in the affirmative (e.g., by selecting a graphical “Yes” button in the prompt message or a physical button on scanning device 102) that the user would like the workflow to be stored and later presented to the user as a workflow option, then scanning device 102 sends the affirmative indication to workflow service 106A. In response, workflow service 106A stores data that indicates that the set of operations is to be considered a workflow. Also, workflow service 106A might also send, to scanning device 102, a name prompt message requesting the user to name the workflow. If the user does not provide a name for the workflow, then workflow service 106A automatically generates a name for the workflow. The name may be based on the set of operations selected by the user. For example, each operation may be associated with a different icon and/or a few characters, such as “EM” for an email operation, “OCR” for an OCR operation, “AUDIO” for a text-to-speech operation, “CONT” for an add-to-contacts operation, and “MMS” for a message operation.

Workflow service 106A may also store association data that indicates that the workflow is only associated with the user and no other user. The association data may be stored in response to additional data sent from scanning device 102, which additional data is sent in response to user selection (e.g., of a checkbox) that indicates that the user would like to associate the workflow only with the user. Alternatively, it is presumed that the user would not like to associate the workflow with other users. In that case, an option may be provided to the user that indicates asks the user if the user would like to allow other users to select the same workflow.

In an embodiment, workflow service 106A compares a current set of operations selected by a user with a previous set of operations selected by the same user or a different user. If workflow service 106A determines that each set of operations is the same, then workflow service 106A prompts the user, as described above. Thus, the prompt may only be sent if this determination is made. In order to be “the same,” each set of operations may have to have been selected in the same order.

5. Providing Workflow Options

Later, workflow service 106A sends, to scanning device 102, workflow information that indicates one or more workflows that a user may select. This workflow information may be sent when, for example, the same (or different) user logs into scanning device 102 or initiates a scan process of one or more printed documents. As a specific example, in response to a HTTP GET request from scanning device 102, workflow service 106A sends a page (e.g., a web page) with data elements to scanning device 102. The data elements, when rendered by a browser executing on scanning device 102, causes one or more workflow options to be displayed on GUI 210. A workflow option may be indicated by a name, an icon, or any other visually characteristic that distinguishes one workflow option from other workflow options that are displayed on GUI 210. Each workflow option may be displayed in a list that indicates a name for the workflow option and, for example, when the workflow option was created and which user caused the workflow option to be created. Additionally or alternatively, each workflow option may be indicated in a separate GUI button on GUI 210. Thus, if there are five workflow options, then five buttons are displayed, one for each workflow option.

A workflow option, when selected (e.g., by user input on GUI 210), causes the set of operations indicated in the corresponding workflow to be performed with respect to a current scan job. User selection of a workflow option may initiate a scan of one or more printed documents. Alternatively, user selection of a workflow option may occur after one or more printed document have been scanned by scanning device 102 and scanned document data has been generated. The set of operations are performed without the user having to individually select each operation in the set. In an embodiment, the user is not required to select any of the operations in the set. The set of operations may be performed in the same order in which a user originally selected the set of operations before the corresponding workflow was created.

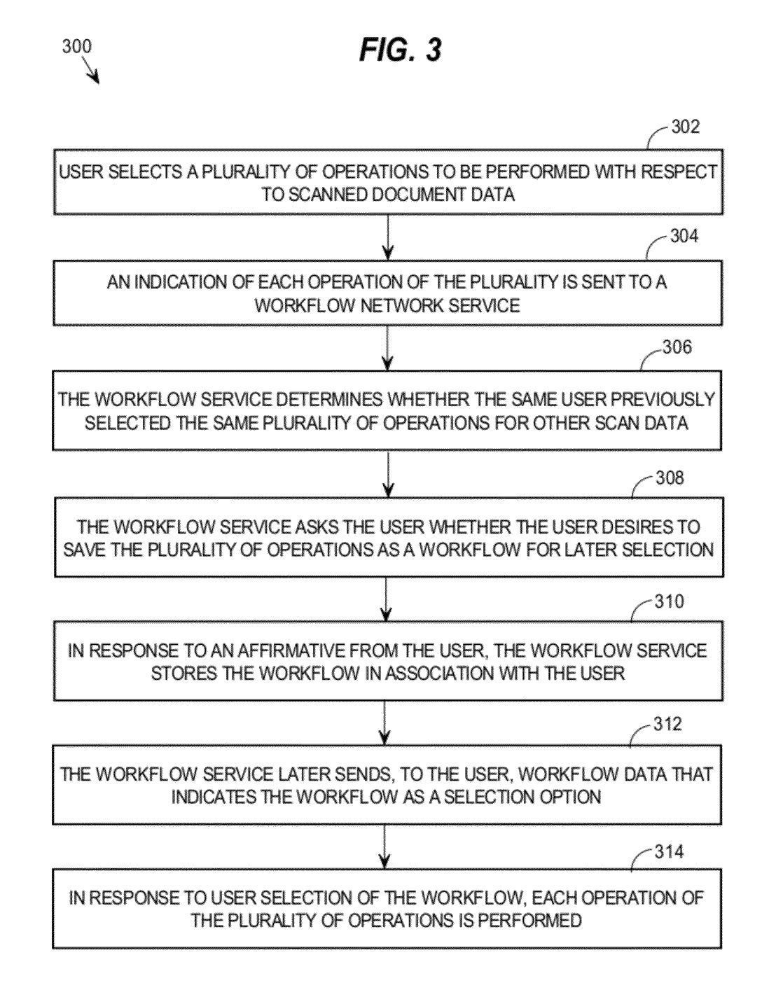

FIG. 3 is a flow diagram 300 that depicts an approach for generating a workflow, according to an embodiment of the invention. In step 302, a user selects a plurality of operations to perform with respect to scanned document data. In step 304, an indication of each operation in the plurality is sent to workflow service 106A.

In step 306, before or after all the plurality of operations are performed, workflow service 106A determines whether the same user previously selected the same plurality of operations with respect to other scanned document data. If so, then, in step 308, workflow service 106A sends, to scanning device 102, a message to be displayed on GUI 210. Workflow service 106A asks the user, via the message, whether the user would like to save that particular plurality of operations as a particular workflow that can be later presented to the user. In step 310, the user responds in the affirmative and workflow service 106A stores the particular workflow in association with the user.

In step 312, when the user is later authenticated at scanning device 102, workflow service 106A sends workflow data that indicates the particular workflow as an option for the user to select. In step 314, in response to user selection of the particular workflow, each operation in the plurality of operations is performed without the user having to individually select each of the plurality of operations.

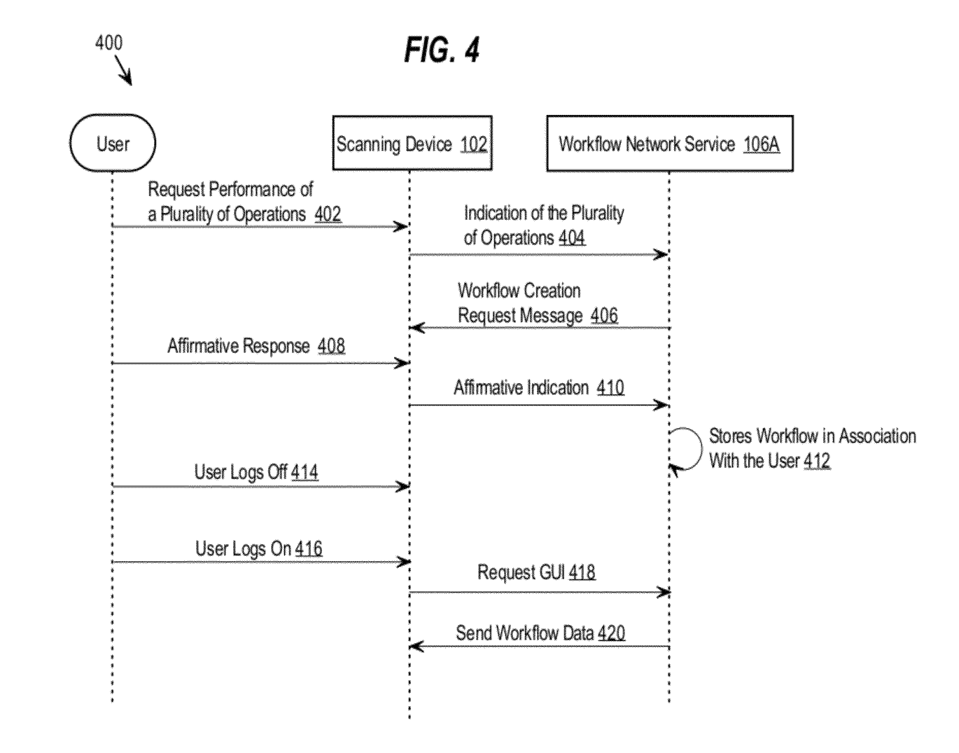

FIG. 4 is a message ladder diagram 400 that depicts an example message exchange between a user and elements of FIG. 1 during the creation of a workflow, according to an embodiment of the invention. In step 402, a user selects a plurality of operations to be performed with respect to scanned document data. In step 404, scanning device 102 sends, to workflow service 106A, data that indicates each of the plurality of operations that were selected by the user. In step 406, workflow service 106A sends, to scanning device 102, a workflow creation request message that is displayed on GUI 210 and that requests the user whether the user would like to save the plurality of operations as a selectable workflow in the future.

In step 408, the user provides an affirmative response. The affirmative response may be provided by the selection of a physical button on scanning device 102 or by the selection of a graphical button displayed within the workflow creation request message. In step 410, scanning device 102 sends, to workflow service 106A, data that indicates the affirmative response. In step 412, workflow service 106A stores a workflow (i.e., that indicates the plurality of operations) in association with the user. Alternatively, the workflow may be stored so that the workflow is provided to any user in a particular group or to all users of scanning device 102.

In step 414, the user logs off of scanning device 102. In step 416, the user logs back into scanning device 102. In step 418, in response to the log in, scanning device 102 transmits a GUI request to workflow service 106A. In step 420, in response to the GUI request, workflow service 106A sends, to scanning device, workflow data that indicates the workflow stored in step 412. The workflow data may also indicate one or more other workflows, whether default workflows, workflows generated by workflow service 106A based on operation selection history, or workflows created by a user (as described in detail below). The workflow is then selectable by the user.

### B. Workflow Builder

According to an embodiment of the invention, a user is allowed to create a workflow. Generation of a workflow in this manner may be performed without the user being required to select each operation and having each operation performed with respect to actual scanned document data. The set of data that allows a user to create a workflow is referred to as “workflow builder data.”

For example, workflow service 106A sends workflow builder data to scanning device 102. Scanning device 102 causes the workflow builder data to be rendered as multiple GUI controls on GUI 210. The multiple GUI controls allow a user at scanning device 102 to select a sequence of operations for inclusion in a workflow without first requiring the user to cause those operations to be performed.

The workflow builder data may be sent to scanning device 102, e.g., in response to the user logging at scanning device 102 or in response to user selection of a button (e.g., displayed on GUI 210) that, when selected, causes a request to be sent, to workflow service 106A, for workflow builder GUI elements to be displayed on GUI 210.

The multiple GUI controls that comprise workflow builder data include GUI elements that represent each operation. The GUI elements that represent each operation may, for example, comprise a selectable line of text in a list that indicates multiple operations or as a selectable button among a plurality of GUI buttons (i.e., that are displayed on GUI 210).

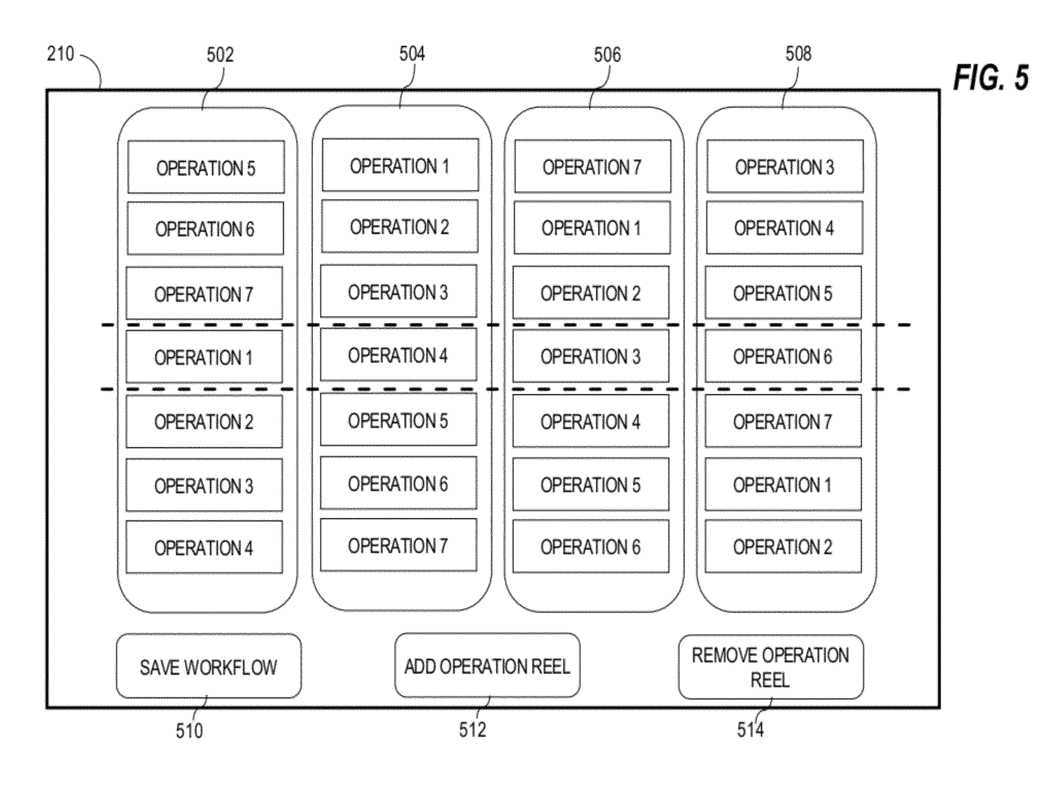

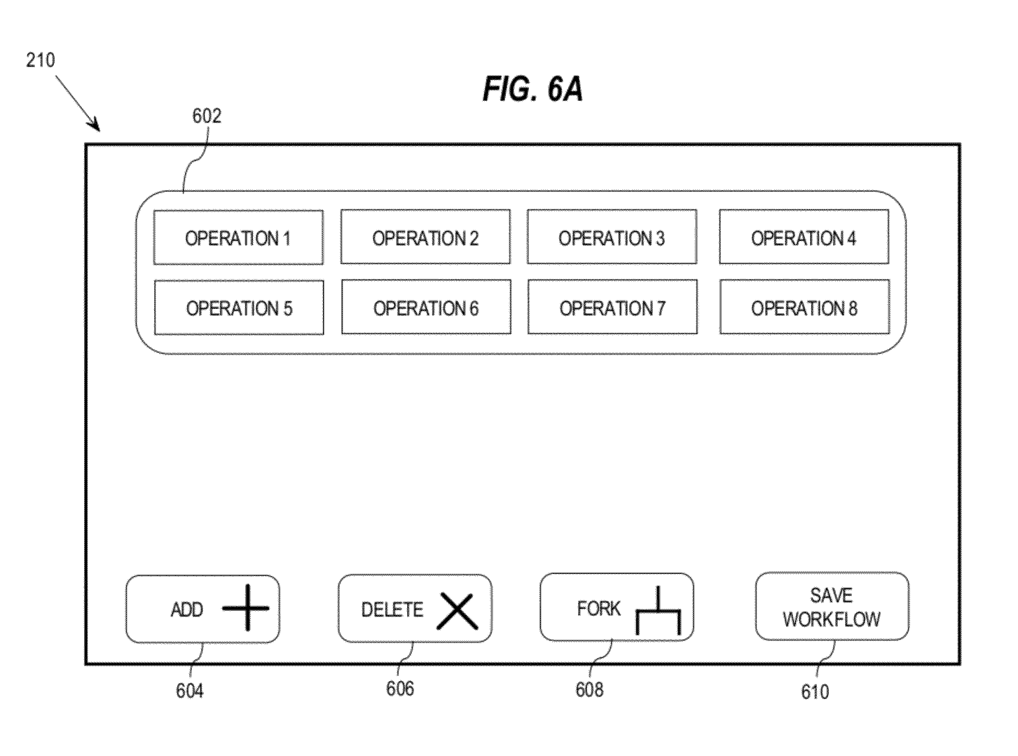

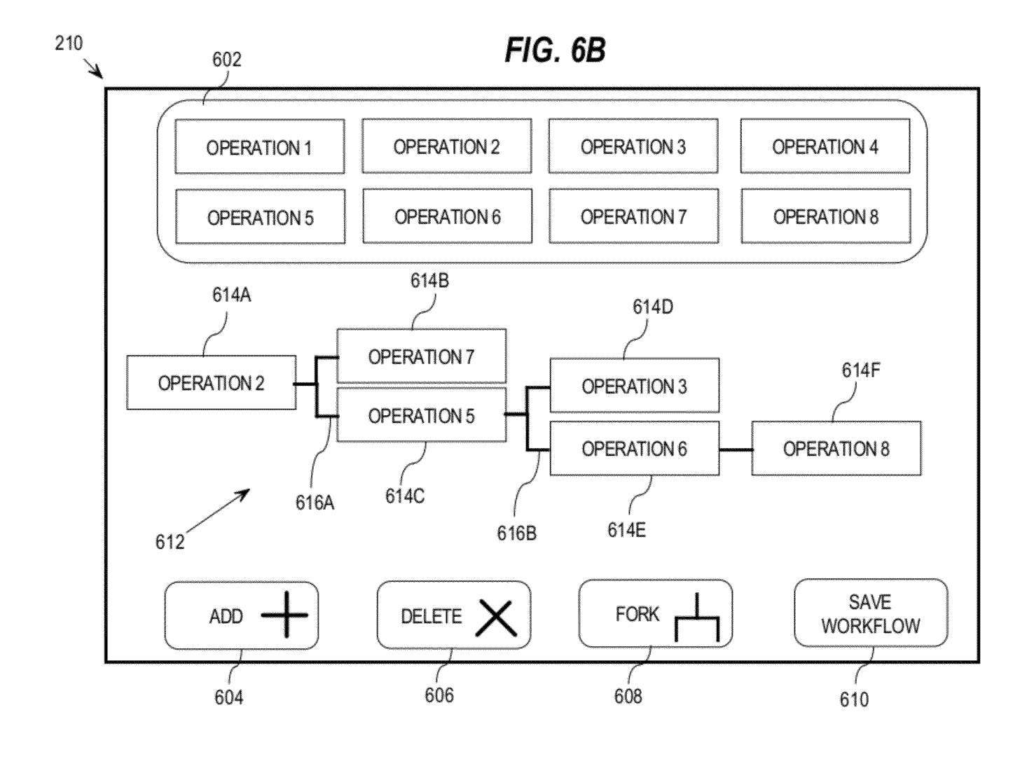

The following description corresponding to FIGS. 5 and 6A-B are in the context of building a workflow and refer to selecting operations. For purposes of brevity, “selecting an operation” is shorthand for “selecting a graphical representation of an operation.” Also, “adding an operation to a workflow” is shorthand for “adding a graphical representation of an operation to a graphical representation of a workflow.” A similar shorthand is used for removing operations from, and moving operations in, a workflow.

1. Simple Workflows

FIG. 5 is a diagram that depicts an example set of GUI controls 502-514 that allow a user to create a workflow, according to an embodiment of the invention. GUI controls 502-514 are displayed via GUI 210. GUI controls 502-508 (or “scroll reels 502-508”) are graphical scroll reels. Each scroll reel contains graphical representations of a number of operations. In this example, each scroll reel contains seven graphical representations of seven operations (i.e., Operations 1-7).

Each graphical scroll reel may be moved via another graphical control, such as user selection of up and down arrows (now shown). Alternatively, each graphical scroll reel may be moved by a user touching the screen with the user's finger and moving the finger up or down on the screen. Each type of user input causes the graphical representations of the operations to be moved within the corresponding scroll reel.

GUI control 510 is a “Save Workflow” button (or “save workflow button 510”). Selection of save workflow button 510 causes the operations that are indicated between the dotted lines in FIG. 5 to be saved as a workflow for later selection. In this example, operations 1, 4, 3, and 6 will be saved as a workflow if button 510 is selected.

GUI control 512 is a “Add Operation Reel” button (or “add reel button 512”). Selection of add reel button 512 causes another scroll reel to be displayed. The other scroll reel might contain the same set of operations (or rather graphical representations of the same set of operations) depicted in another scroll reel. Alternatively, the other reel might contain a different set of operations. Operations that are depicted in a new scroll reel might be chosen based on which operations have already been selected in the current workflow that is being created.

GUI control 514 is a “Remove Operation Reel” button (or “remove reel button 514”). Selection of remove reel button 514 causes the last reel displayed via GUI 210 to be removed. Alternatively, a user might select one of the scroll reels (e.g., scroll reel 504) and then select remove reel button 514. Removing an intermediate scroll reel, such as scroll reel 504 might automatically cause the preceding and succeeding scroll reels (e.g., scroll reels 502 and 506) to move closer together, indicating that the operation indicated in scroll reel 506 comes immediately after the operation indicated in scroll reel 502.

2. Complex Workflows

The above example is of a simple workflow. However, a user may require multiple operations to be performed on different types of data in the same workflow. Thus, workflow builder data may comprise additional and/or alternative controls than those described above with reference to FIG. 5.

Further, some operations, when executed, might require only one type of data as input and produce only one type of data as output. Such operations are referred to as “single-type operations.” For example, a particular scan operation may be a single-type operation in that the particular scan operation produces scanned document data in a single format. As another example, a particular OCR operation may be a single-type operation in that the particular OCR operation requires scanned document data in a particular format (e.g., in PDF format) as input and produces text data in only a particular format (e.g., in Word format) as output. As yet another example, a particular text-to-speech operation might require text data in a particular format (e.g., Word format) as input and produce audio data in a particular format (e.g., in mp3 format) as output.

Some operations, on the other hand, might be able to accept multiple types of data as input and/or produce multiple types of data as output, depending on the circumstances. Such operations are referred to as “multi-type operations.” For example, a message operation, an email operation, a text-to-speech operation, a store operation, and an update contacts operation (i.e., that detects contact data in scanned document data) might take either a PDF document or a Word document as input. Depending on the circumstances, a user might desire to have a PDF of a scanned document emailed to one recipient and a Word version of the same scanned document sent via MMS to another recipient. Thus, the placement of an operation within a workflow might have a significant impact on whether the operation may be performed and even on what data is produced by the operation.

To allow for such scenarios, workflow service 106A provides, to scanning device 102, one or more GUI elements that allow a user to dictate when certain operations are to be performed relative to other operations in a workflow. (In the embodiment where scanning device 102 provides the functionality for building a workflow, scanning device 102 comprises and/or provides one or more user interface controls that allow a user to indicate when certain operations are to be performed relative to other operations.) For example, a fork GUI object displayed on GUI 210 may be selected and moved to the right side of a graphical representation (e.g., a selectable line of text or an icon) of a selected operation, indicating that the output of the selected operation is to be operated on by two or more operations. Although a two- or three-pronged fork GUI object should be sufficient for most workflows, there is no limit to the number of prongs of the fork GUI object. Then, the user selects multiple operations and “drags” each to the end of one of the prongs of the fork GUI object.

FIGS. 6A-B are block diagrams that depict GUI controls 602-610 that are displayed via GUI 210 and that allow a user to build a workflow, according to an embodiment of the invention.

GUI control 602 (or “operation selection region 602”) is a region of GUI 210 that displays each selectable operation. In this example, operation selection region 602 includes eight operations (i.e., Operations 1-8).

GUI control 604 (or “add button 604”) allows a selected operation to be added to a workflow that is in progress of being built. For example, a user selects “Operation 1” in operation selection region 602 and then selects add button 604. This sequence of selections causes “Operation 1” to be added to a workflow. In an alternative embodiment, add button 604 is not necessary. Instead, selection of an operation in operation selection region 602 causes the operation to be added to the workflow.

GUI control 606 (or “delete button 606”) allows an operation to be removed from a workflow. For example, a user selects a particular operation in a workflow (whether the workflow is under construction or the workflow is an existing workflow) and then selects delete button 606. This sequence of selections causes the particular operation to be removed from the workflow.

GUI control 608 (or “fork button 608”) allows multiple operations to be the recipients of the output generated by a single operation. Selection of fork button 608 causes a fork GUI object to be displayed. A user may drag the fork GUI object to one side of a particular operation in a workflow. A workflow may contain any number of fork GUI objects.

GUI control 610 (or “save workflow button 610”) allows a workflow displayed via GUI 210 to be saved for later retrieval and selection. Thus, selection of save workflow button 610 causes the sequence of operations and any forks indicated in the displayed workflow to be saved in persistent storage.

3. Building a Workflow Example

FIG. 6B is a diagram that depicts elements from FIG. 6A as well as a user-created workflow 612, according to an embodiment of the invention. In order to create workflow 612, a user performed the following steps:
(1) selection of Operation 2 in operation selection region 602;
(2) selection of add button 604;
(3) selection of fork button 608;
(4) selection of Operation 7 in operation selection region 602;
(5) selection of add button 604;
(6) selection of Operation 5 in operation selection region 602;
(7) selection of add button 604;
(8) selection of fork button 608;
(9) selection of Operation 3 in operation selection region 602;
(10) selection of add button 604;
(11) selection of Operation 6 in operation selection region 602; and
(12) selection of add button 604;
(13) selection of Operation 8 in operation selection region 602; and
(14) selection of add button 604;

Steps 1-2 causes scan operation GUI object 614A) to be displayed elsewhere on GUI 210. Alternatively, step 2 (and steps 5, 7, 10, 12, and 14) is not necessary. Thus, Operation 2 corresponds to a scan operation. In an embodiment, user selection of an operation in operation selection region 602 causes that operation to be displayed in another portion of the display. Each subsequent user selection of an operation in operation selection region 602 causes the operation to be displayed in that same portion of the display, such as to the right or below the previously-selected operation. In this manner, a user is able to view what operations the user has selected thus far and the order in which the operations were selected.

Step 3 may cause fork GUI object 616A to be automatically attached to the right side of scan operation GUI object 614A. Alternatively, step 3 further comprises the user “dragging” fork GUI object 616A to the right side of scan operation GUI object 614A.

Steps 4-5 causes email GUI object 614B (representing Operation 7) to be displayed on GUI 210. Thus, Operation 7 corresponds to an email operation. User selection of Operation 7 in operation selection region 602 may cause email GUI object 614B to be automatically attached to the first prong of fork GUI object 616A. Otherwise, the user “drags” email GUI object 614B so that a prong of fork GUI object 616A touches the left side of email GUI object 614B. Placement of email GUI object 614B in this manner indicates that an email message will be sent that include the scanned document data generated by the scan operation indicated by scan GUI object 614A.

Steps 6-7 causes OCR GUI object 614C (representing Operation 5) to be displayed on GUI 210. Thus, Operation 5 corresponds to an OCR operation. User selection of the Operation 5 in operation selection region 602 may cause OCR GUI object 614C to be automatically attached to the second prong of fork GUI object 616A. Otherwise, the user “drags” OCR GUI object 614C so that a prong of fork GUI object 616A touches the left side of OCR GUI object 614C. Placement of OCR GUI object 614C in this manner indicates that an OCR operation will be performed on the scanned document data generated by the scan operation indicated by scan GUI object 614A.

Step 8 may cause fork GUI object 616B to be automatically attached to the right side of OCR GUI object 614C. Alternatively, step 8 further comprises the user “dragging” fork GUI object 616B to the right side of OCR GUI object 614C.

Steps 9-10 causes store GUI object 614D (representing Operation 3) to be displayed on GUI 210. Thus, Operation 3 corresponds to another store operation. There may be multiple store operations to choose from. For example, a first store operation may be to store data in storage 116 of scanning device 102. A second store operation may be to store data in storage 122 of cloud 104. A third store operation may be to store data in storage maintained by one of other network services 110. As part of step 10, the user may place store GUI object 614D after one of the prongs of fork GUI object 616B. This signifies that the store operation (represented by store GUI object 614D) will accept the text data (generated by the OCR operation) as input and will cause the text data to be stored, e.g., in storage 122.

Steps 11-12 causes text-to-speech GUI object 614E (representing Operation 6) to be displayed on GUI 210. Thus, Operation 6 corresponds to a text-to-speech operation. User selection of Operation 6 in operation selection region 602 may cause text-to-speech GUI object 614E to be automatically attached to the second prong of fork GUI object 616B. Otherwise, the user “drags” text-to-speech GUI object 614E so that a prong of fork GUI object 616B touches the left side of text-to-speech GUI object 614E. Placement of text-to-speech GUI object 614E in this manner indicates that the text-to-speech operation indicated by GUI object 614E will accept the text data (generated by the OCR operation indicated by OCR GUI object 614C) as input and generate audio data as output.

If the text-to-speech operation is one that can take either scanned document data or text data as input, then the user may provide additional input to indicate as to where a text-to-speech GUI object should be placed. A text-to-speech GUI object may be placed after an OCR GUI object, signifying that the input to the text-to-speech operation is to be based on the output of an OCR operation. Alternatively, a text-to-speech GUI object may be placed after a scan GUI object, signifying that the input to the text-to-speech GUI object is to be based on the output of the scan operation.

Steps 13-14 causes store GUI object 614F (representing Operation 8) to be displayed on GUI 210. Thus, Operation 8 corresponds to a store operation. User selection of Operation 8 in operation selection region 602 may cause store GUI object 614F to be automatically attached to text-to-speech GUI object 614E (i.e., the most-recently added GUI object). Otherwise, the user “drags” store GUI object 614F so that store GUI object 614F approaches the right side of text-to-speech GUI object 614E. In either scenario, the link that connects GUI object 614E to GUI object 614F may be automatically generated. Placement of store GUI object 614F in this manner indicates that the audio data (generated by the text-to-speech operation indicated by GUI object 614E) will be stored, e.g., in storage 116 or 122.

In an embodiment, a user is able to move the links that link GUI objects 614A-F. For example, a user may move the link that connects GUI object 614E to GUI object 614F so that the link touches GUI object 614B or GUI object 614D. Movement of the link may also cause the GUI object on the right side of the link to be moved as well. Alternatively, movement of a GUI object 614 may cause a link to move as well. For example, moving GUI object 614F to a position near the right side of GUI object 614D may causes the link that connects GUI object 614E to GUI object 614F to be moved as well.

4. Storing a Workflow

In an embodiment, once a user creates a workflow, the user provides a name for the workflow, for example, after being prompted by workflow service 106A through a name request prompt displayed on GUI 210. The user may also be prompted to indicate whether the user would like to make the workflow “public” so that other users may view the same workflow as a selectable option and use that workflow for their respective scan jobs.

The workflow is saved either in storage 116 (of scanning device 102), storage 122 (of cloud 104), or in storage maintained by one of other network services 110 (i.e., outside cloud 104). Later, the workflow may be retrieved by workflow service 106A in response to various situations. For example, when a user logs into scanning device 102, scanning device 102 sends a request to workflow service 106A. The request may not be specific to workflow data. The request may be a generic request to provide a GUI to be displayed at scanning device 102. In response to the request, workflow service 106A provides the workflow (and any other previously-generated workflows) to scanning device 102.

Previously-generated workflows may include default workflows that have been generated, for example, by the manufacturer of scanning device 102, by the entity that maintains cloud 104, or by a third party.

As another example, a user may select a button (e.g., displayed on GUI 210) that explicitly requests workflow options to be displayed to the user.

### C. Modifying a Workflow

According to an embodiment of the invention, a user modifies an existing workflow to create another workflow. The existing workflow may have been generated by a network service (as described above under the section entitled “AUTOMATIC WORKFLOW GENERATION”), may have been created by a user (as described under the section “WORKFLOW BUILDER”), or may be a default workflow that is created by another technique. Workflow service 106A provides one or more GUI elements to be displayed on GUI 210 to allow a user to (a) select an existing workflow, (b) delete operations indicated in the existing workflow, (c) add operations at any point in the existing workflow, and (d) move operations indicated in the existing workflow to other places in the existing workflow.

A user may select an existing workflow in any manner. Selecting an existing workflow comprises, for example, user selection of a graphical button or a line of text that identifies the workflow. User selection of an existing workflow causes the operations (or rather representations thereof) indicated by the workflow to be displayed on GUI 210. A user can then select each operation individually from the graphical representation of the workflow.

Thus, deleting an operation from an existing workflow may comprise user selection of a graphical representation of the operation and then selecting a graphical delete button. Adding an operation to an existing workflow may comprise user selection of an operation dragging the operation to a particular position within the workflow. “Dropping” the operation at the particular position causes the selected operation to be inserted into the workflow at (or near) the particular position.

In an embodiment, modifying an existing workflow comprises modifying a copy of the existing workflow. Thus, the original existing workflow is not modified when the copy is modified. Alternatively, there is only one copy of an existing workflow and modifying an existing workflow modifies that one copy. In other words, the version of the existing workflow that existed prior to the modification no longer exists.

### IV. Implementation Mechanisms

Although the flow diagrams of the present application depict a particular set of steps in a particular order, other implementations may use fewer or more steps, in the same or different order, than those depicted in the figures.

According to one embodiment of the invention, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

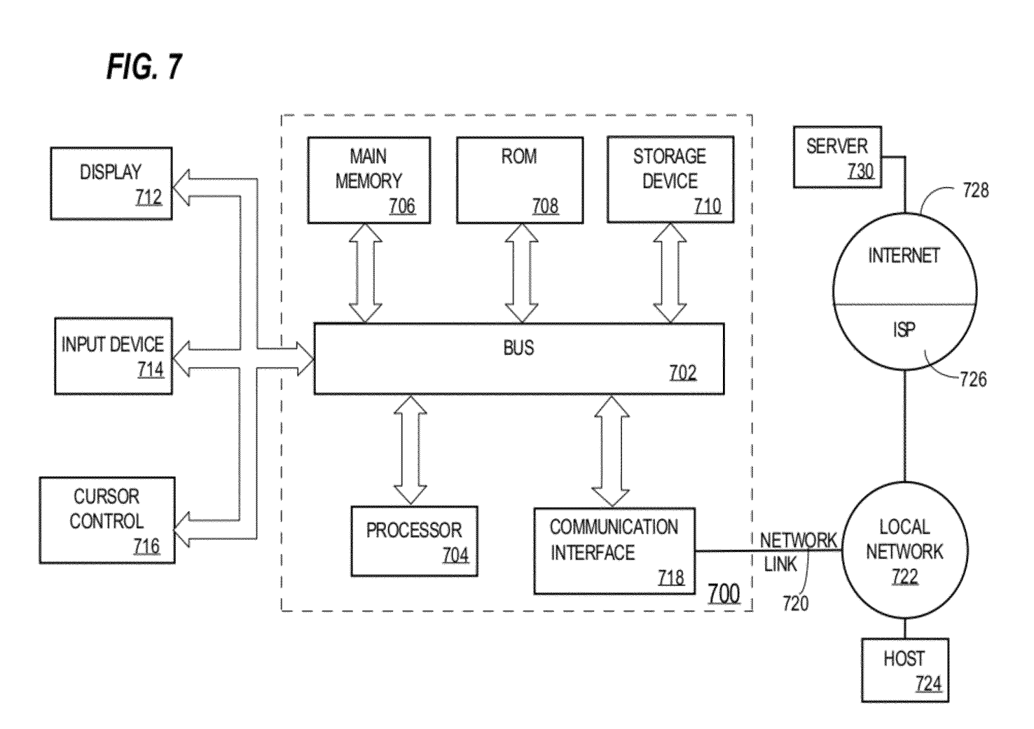

FIG. 7 is a block diagram that depicts an example computer system 700 upon which embodiments of the invention may be implemented. Computer system 700 includes a bus 702 or other communication mechanism for communicating information, and a processor 704 coupled with bus 702 for processing information. Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic or computer software which, in combination with the computer system, causes or programs computer system 700 to be a special-purpose machine. According to one embodiment of the invention, those techniques are performed by computer system 700 in response to processor 704 executing one or more sequences of one or more instructions contained in main memory 706. Such instructions may be read into main memory 706 from another computer-readable medium, such as storage device 710. Execution of the sequences of instructions contained in main memory 706 causes processor 704 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing data that causes a computer to operation in a specific manner. In an embodiment implemented using computer system 700, various computer-readable media are involved, for example, in providing instructions to processor 704 for execution. Such a medium may take many forms, including but not limited to, non-volatile media and volatile media. Non-volatile media includes, for example, optical or magnetic disks, such as storage device 710. Volatile media includes dynamic memory, such as main memory 706. Common forms of computer-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or memory cartridge, or any other medium from which a computer can read.

Various forms of computer-readable media may be involved in carrying one or more sequences of one or more instructions to processor 704 for execution. For example, the instructions may initially be carried on a magnetic disk of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718. The received code may be executed by processor 704 as it is received, and/or stored in storage device 710, or other non-volatile storage for later execution.

In the foregoing specification, embodiments of the invention have been described with reference to numerous specific details that may vary from implementation to implementation. Thus, the sole and exclusive indicator of what is, and is intended by the applicants to be the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. One or more storage media storing instructions for automatically generating a workflow, wherein the instructions, when processed by one or more processors, cause:
in response to initiation of a first performance of each operation of a plurality of operations that are performed in association with scanned document data generated by a scanning device, generating workflow data that indicates each of the plurality of operations;
causing said workflow data to be stored; and
after the workflow data is stored and in response to a user interacting with the scanning device, causing, based on the workflow data, a graphical element to be displayed on a graphical user interface (GUI) of the scanning device;
wherein selection of the graphical element causes a second performance of each of the plurality of operations to be initiated.

2. The one or more storage media of claim 1, wherein:
causing the workflow data to be stored comprises causing the workflow data to be stored in association with the user;
wherein the instructions, when processed by the one or more processors, further cause retrieving said workflow data based on the identity of the user.

3. The one or more storage media of claim 1, wherein:
the user initiated the first performance of each operation of the plurality of operations;
wherein the instructions, when processed by the one or more processors, further cause, in response to the first performance of each operation of the plurality of operations, causing a message to be displayed on the GUI of the scanning device, wherein the message provides an option, to the user, to save the plurality of operations as a particular workflow;
the workflow data is stored in response to the user selecting the option.

4. The one or more storage media of claim 1, wherein:
causing workflow data to be stored comprises at least one of (a) a workflow network service receiving, from the scanning device over a network, using an IP protocol, the workflow data and storing the workflow data or (b) storing the workflow data in memory of the scanning device.

5. The one or more storage media of claim 1 wherein:
the workflow data indicates the order in which the plurality of operations were performed during the first performance; and
the plurality of operations are performed in the same order during the second performance of each operation of the plurality operations.

6. The one or more storage media of claim 1, wherein the instructions, when processed by the one or more processors, further cause:
prior to the user initiating the first performance of each operation of the plurality of operations:
causing the performance of each operation of a second plurality of operations that were initiated by a second user, and
causing previous workflow data to be stored, wherein the previous workflow data indicates each of the second plurality of operations; and
in response to the user initiating the first performance of each operation of the plurality of operations, comparing the plurality of operations against the second plurality of operations indicated in the previous workflow data, to determine whether the second plurality of operations is the same as the plurality of operations.

7. The one or more storage media of claim 1, wherein the plurality of operations include at least one of:
scanning one or more printed documents to create the scanned document data;
faxing the scanned document data;
performing optical character recognition on the scanned document data to generate text data;
emailing at least one of the scanned document data or the text data to one or more recipients;
sending at least one of the scanned document data or the text data to one or more mobile devices;
converting said text data into audio data;
performing one or more security operations on at least one of the scanned document data or the text data; or
storing at least one of the scanned document data or the text data by a network service that is addressable by an IP address.

8. One or more storage media storing instructions for graphically displaying workflow elements, wherein the instructions, when processed by one or more processors, cause:
causing a plurality of graphical elements to be displayed on a graphical user interface (GUI) of a scanning device, wherein the plurality of graphical elements allow a user to create a workflow;
wherein the workflow represents a plurality of operations that, upon user selection of the workflow, are executed without requiring separate user input to initiate performance of each of the plurality of operations;
in response to creation of the workflow, storing workflow data that indicates the workflow for later retrieval;
after storing the workflow, causing a particular graphical element to be displayed on the GUI of the scanning device, wherein the particular graphical element represents the workflow; and
in response to user selection of the particular graphical element, causing the plurality of operations, associated with the workflow, to be performed without requiring separate user input to initiate performance of each of the plurality of operations.

9. The one or more storage media of claim 8, wherein:
causing the plurality of graphical elements to be displayed comprises receiving, from a workflow network service, at the scanning device, workflow builder data that represents the plurality of graphical elements;
storing the workflow is performed by the workflow network service; and
causing the particular graphical element to be displayed comprises, receiving, from the workflow network service, at the scanning device, workflow data that indicates the workflow.

10. The one or more storage media of claim 8, wherein the plurality of graphical elements allow a user to (a) remove a particular operation from the workflow, (b) change the order in which the particular operation is to be performed relative to other operations in the workflow, or (c) add a new operation to the workflow.

11. An apparatus for automatically generating a workflow, wherein the apparatus comprises:
one or more processors;
one or more computer-readable storage media storing instructions which, when processed by the one or more processors, cause:
in response to initiation of a first performance of each operation of a plurality of operations that are performed in association with scanned document data generated by a scanning device, generating workflow data that indicates each of the plurality of operations;
causing said workflow data to be stored; and
after the workflow data is stored and in response to a user interacting with the scanning device, causing, based on the workflow data, a graphical element to be displayed on a graphical user interface (GUI) of the scanning device;
wherein selection of the graphical element causes a second performance of each of the plurality of operations to be initiated.

12. The apparatus of claim 11, wherein:
causing the workflow data to be stored comprises causing the workflow data to be stored in association with the user;
wherein the instructions, when processed by the one or more processors, further cause retrieving said workflow data based on the identity of the user.

13. The apparatus of claim 11, wherein:
the user initiated the first performance of each operation of the plurality of operations;
wherein the instructions, when processed by the one or more processors, further cause, in response to the first performance of each operation of the plurality of operations, causing a message to be displayed on the GUI of the scanning device, wherein the message provides an option, to the user, to save the plurality of operations as a particular workflow;
the workflow data is stored in response to the user selecting the option.

14. The apparatus of claim 11, wherein:
causing workflow data to be stored comprises at least one of (a) a workflow network service receiving, from the scanning device over a network, using an IP protocol, the workflow data and storing the workflow data or (b) storing the workflow data in memory of the scanning device.

15. The apparatus of claim 11, wherein:
the workflow data indicates the order in which the plurality of operations were performed during the first performance; and
the plurality of operations are performed in the same order during the second performance of each operation of the plurality operations.

16. The apparatus of claim 11, wherein the instructions, when processed by the one or more processors, further cause:
prior to the user initiating the first performance of each operation of the plurality of operations:
causing the performance of each operation of a second plurality of operations that were initiated by a second user, and
causing previous workflow data to be stored, wherein the previous workflow data indicates each of the second plurality of operations; and
in response to the user initiating the first performance of each operation of the plurality of operations, comparing the plurality of operations against the second plurality of operations indicated in the previous workflow data, to determine whether the second plurality of operations is the same as the plurality of operations.

17. The apparatus of claim 11, wherein the plurality of operations include at least one of:
scanning one or more printed documents to create the scanned document data;
faxing the scanned document data;
performing optical character recognition on the scanned document data to generate text data;
emailing at least one of the scanned document data or the text data to one or more recipients;
sending at least one of the scanned document data or the text data to one or more mobile devices;
converting said text data into audio data;
performing one or more security operations on at least one of the scanned document data or the text data; or storing at least one of the scanned document data or the text data by a network service that is addressable by an IP address.
